(19) United States
(12) Patent Application Publication
(10) Pub. No.: US 2014/0140247 A1
(43) Pub. Date: May 22, 2014

(54) ENHANCING RELIABILITY OF VoLTE EMERGENCY CALLS

(71) Applicant: QUALCOMM Incorporated, San Diego, CA (US)

(72) Inventor: Madhusudan Kinthada Venkata, San Diego, CA (US)

(73) Assignee: QUALCOMM Incorporated, San Diego, CA (US)

(21) Appl. No.: 14/059,397

(22) Filed: Oct. 21, 2013

Related U.S. Application Data
(60) Provisional application No. 61/728,197, filed on Nov. 19, 2012.

(51) Int. Cl. H04W 4/22

(52) U.S. Cl. CPC H04W 4/22
USPC 370/259

(57) ABSTRACT

A method, an apparatus, and a computer program product for wireless communication are provided. The apparatus ensures that emergency calls may be reliably carried on packet-switched data networks in mobility applications. In one configuration, a time-to-trigger (TTT) parameter, corresponding to a time by which a user equipment (UE) delays transmission of a measurement report, may be reduced when an emergency voice call is provided on a packet-switched data network. In another configuration, when an emergency voice call is to be handed-off, uplink power level to be used for transmissions on an uplink random access channel may be increased above a power level calculated based on estimated downlink path loss. In another configuration, one or more of a semi-persistent scheduling rate of a bearer and a maximum radio link control threshold may be modified when the emergency voice call is established.

### CROSS-REFERENCE TO RELATED APPLICATION(S)

This application claims the benefit of U.S. Provisional Application Ser. No. 61/728,197, entitled “Enhancing Reliability of VoLTE Emergency Calls” and filed on Nov. 19, 2012, which is expressly incorporated by reference herein in its entirety.

### BACKGROUND

1. Field

The present disclosure relates generally to communication systems, and more particularly, to a network in which emergency calls are provided in a packet-switched network.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, methods, computer program products, and apparatus are provided. The apparatus may be configured to ensure that emergency calls may be reliably carried on LTE networks in mobility applications.

In one aspect of the disclosure, an emergency voice call is provided on an LTE network, and a time-to-trigger (TTT) parameter associated with the LTE network may be reduced. The TTT parameter corresponds to a time by which a user equipment (UE) in the LTE network delays transmission of a network measurement report. The TTT parameter may be reduced by transmitting a scaling factor to the UE. The scaling factor corresponds to a factor by which a UE modifies a TTT defined for non-emergency voice calls provided on the LTE network. The TTT parameter may be reduced to a minimum value, thereby causing the UE to transmit the network measurement report without delay. The TTT parameter may be reduced in response to a triggering event. The triggering event may occur when an estimated quality of a serving radio access network is less than a first threshold quality, and an estimated quality of a target radio access network is greater than a second threshold quality.

In another aspect of the disclosure, a method of wireless communication comprises determining that an emergency voice call is to be handed-off to an LTE network, determining path loss in a downlink RACH of the LTE network, calculating an uplink power level to be used for transmissions on an uplink RACH, the uplink power level being based on the path loss in the downlink RACH, and transmitting a RACH preamble on the uplink RACH using a power level greater that the power level calculated based on the path loss in the downlink RACH. Transmitting the RACH preamble on the uplink RACH may include applying a multiplier to a power level calculated based on the path loss in the downlink RACH. Calculating the uplink power level to be used for transmissions on the uplink RACH may include overestimating the path loss of the downlink RACH. Transmitting the RACH preamble on the uplink RACH using a power level greater that the power level calculated based on the path loss in the downlink RACH may include increasing a ramp-up power step. The ramp-up power step is used to increase the power level of successive ramp-up RACH transmissions of the RACH preamble.

In another aspect of the disclosure, a method of wireless communication comprises providing an emergency voice call using a LTE network, and increasing one or more of a semi-persistent scheduling (SPS) rate of a bearer associated with the emergency voice call, and a maximum radio link control threshold. The SPS rate may be increased to a rate greater than a frame rate of a vocoder that handles the emergency voice call. The maximum radio link control threshold may be increased for acknowledgement mode radio link control communications associated with the emergency call.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating certain aspects of handoff in a wireless access network.

FIG. 8 includes first, second and third flow charts of methods of wireless communication.

FIG. 9 is a flow diagram illustrating the data flow between different modules/means/components in an exemplary apparatus implementing the first flow chart of FIG. 8.

FIG. 10 is a diagram illustrating an example of a hardware implementation for an apparatus employing a processing system to implement the first flow chart of FIG. 8.

FIG. 11 is a flow diagram illustrating the data flow between different modules/means/components in an exemplary apparatus implementing the second flow chart of FIG. 8.

FIG. 12 is a diagram illustrating an example of a hardware implementation for an apparatus employing a processing system to implement the second flow chart of FIG. 8.

FIG. 13 is a flow diagram illustrating the data flow between different modules/means/components in an exemplary apparatus implementing the third flow chart of FIG. 8.

FIG. 14 is a flow diagram illustrating the data flow between different modules/means/components in an exemplary apparatus to implement the third flow chart of FIG. 8.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

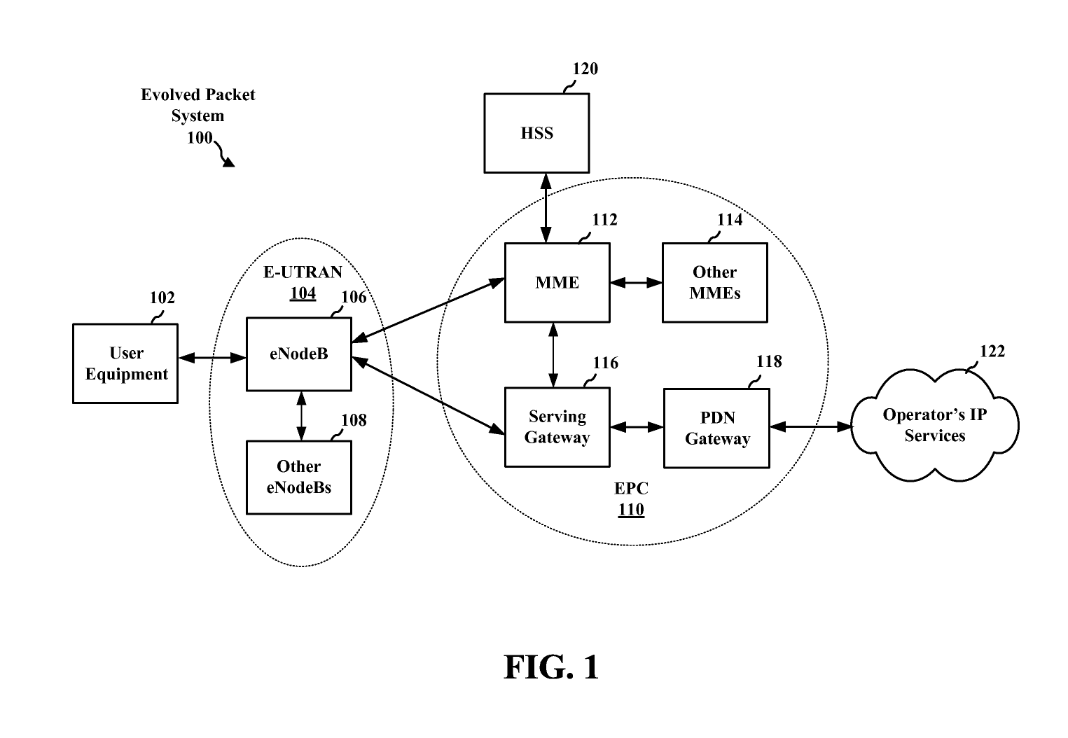

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS).

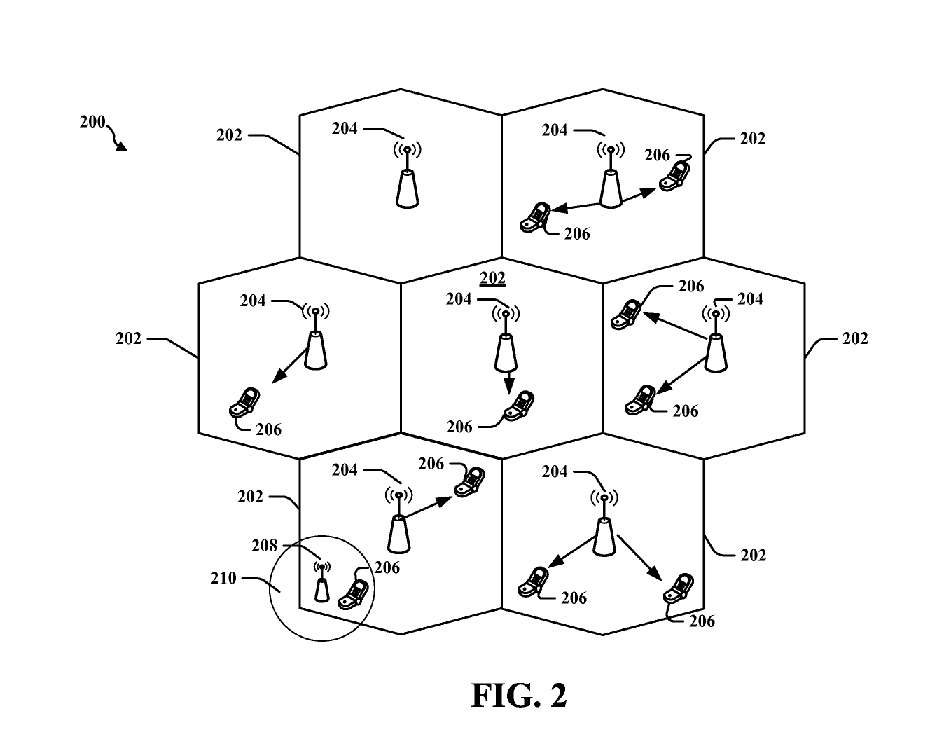

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

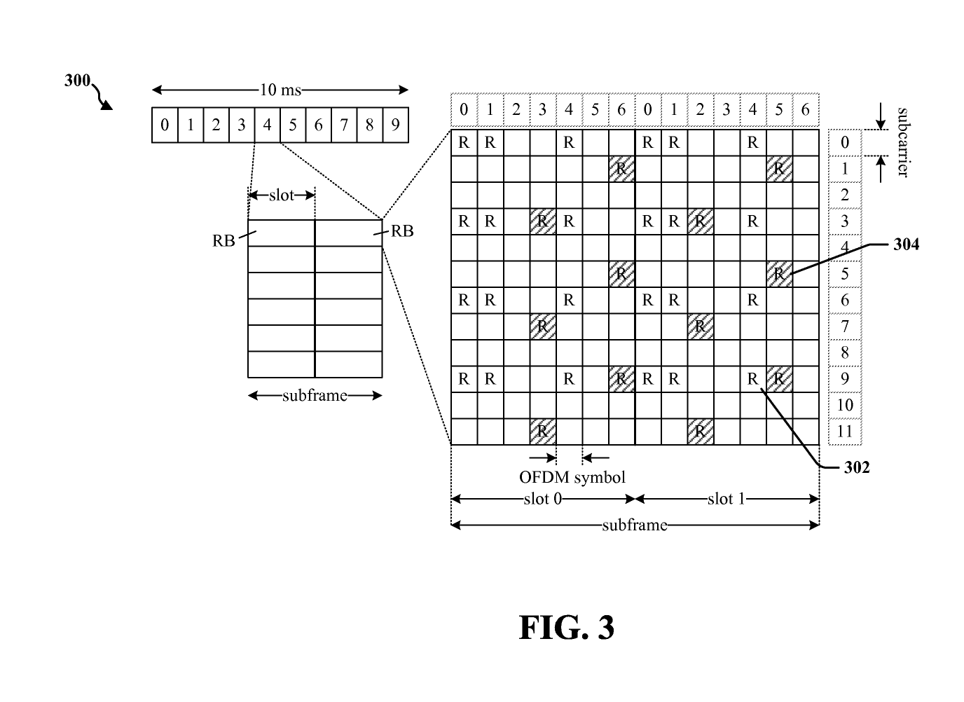

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

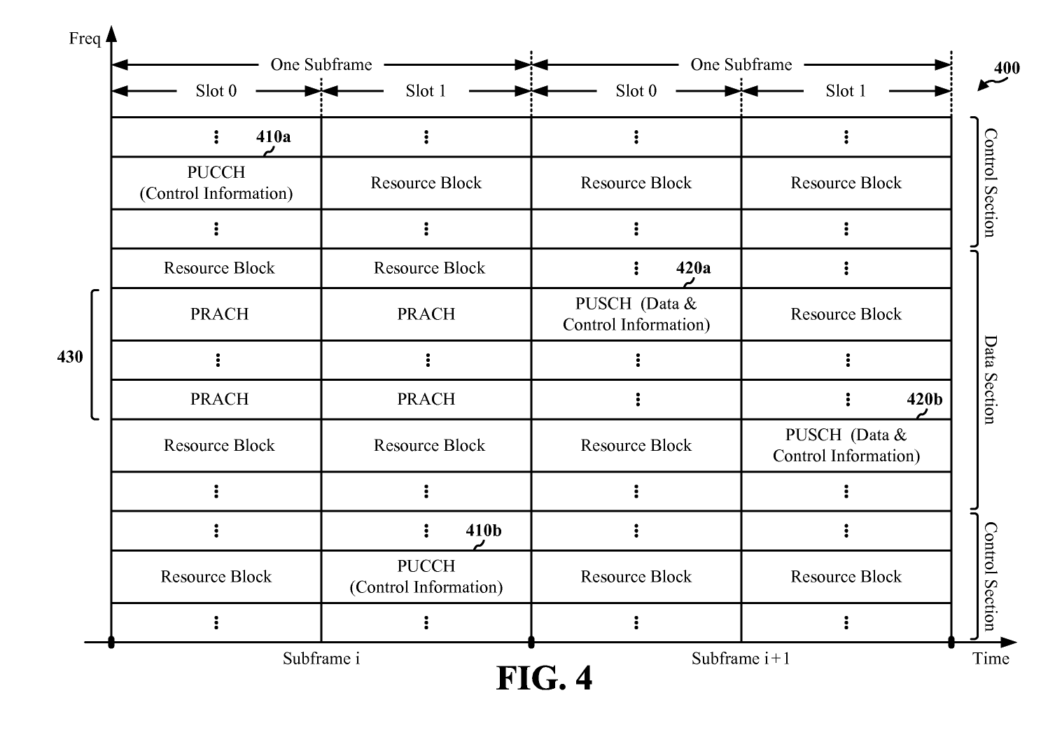

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

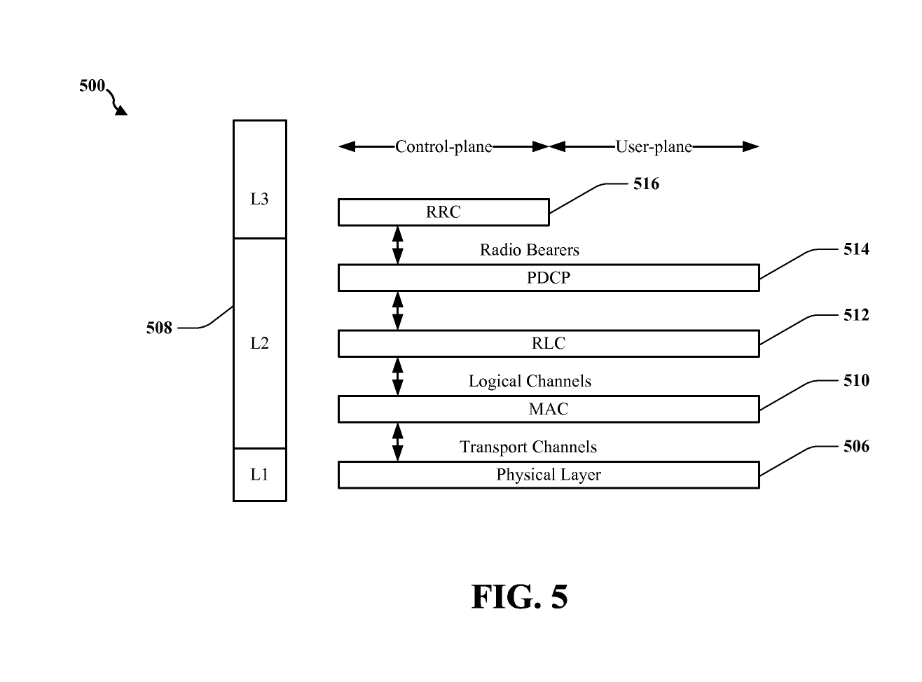

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARM). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

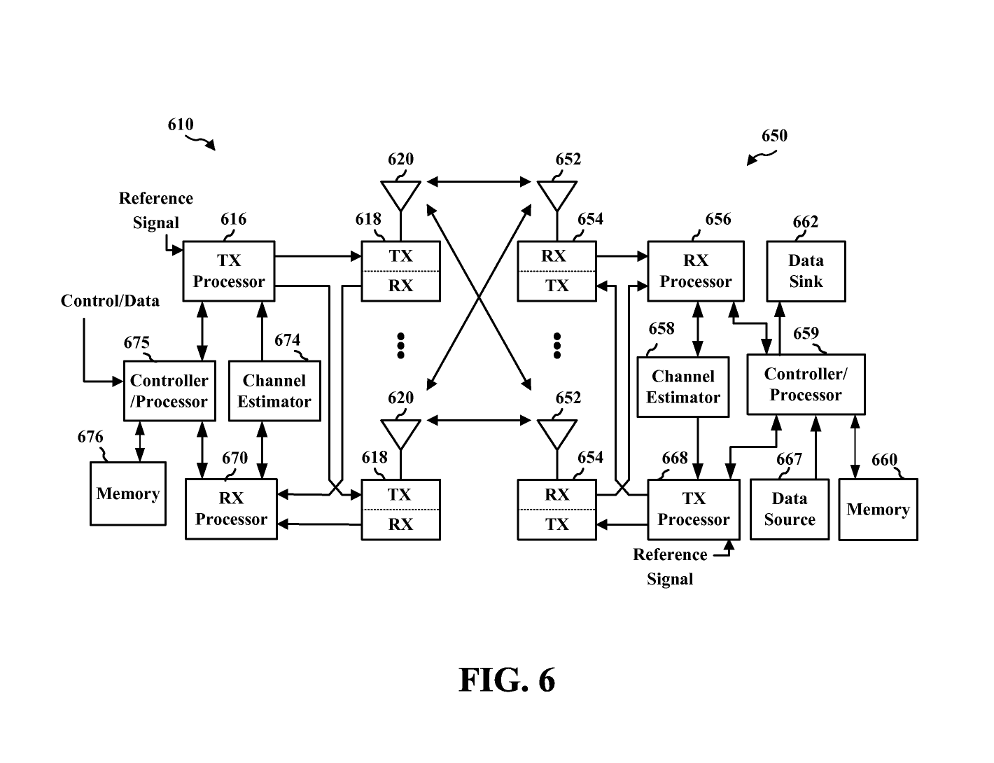

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Certain embodiments provide systems and methods that enable reliable handoff of emergency calls established and/or maintained in an LTE network. The emergency calls may be handled using voice over LTE (VoLTE) service. Voice calls may be handed over from a first radio access network (RAN) to a second RAN when, for example, it is determined that the second RAN can provide a better quality of service than the first RAN, when the second RAN operates using a more preferred radio access technology (RAT), or when the second RAN is provided by the operator of a home network of a UE while the UE is in a roaming mode in the first network. Other reasons may be considered when determining when a call should be handed off.

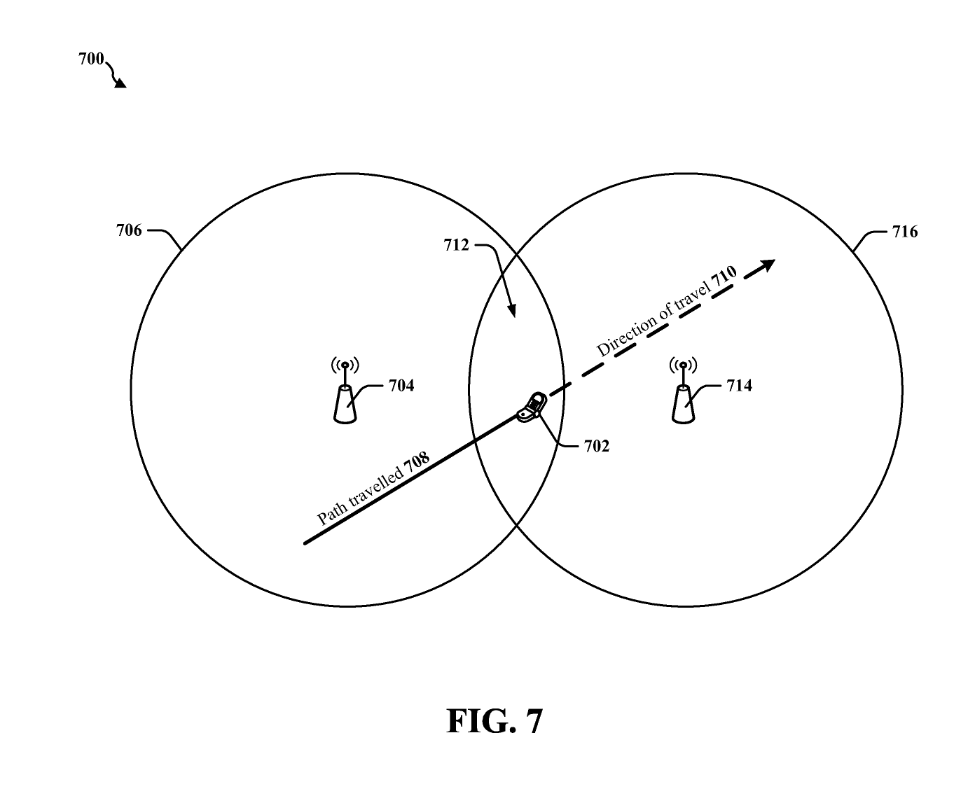

FIG. 7 is a diagram 700 that illustrates a generalized and simplified example illustrating certain aspects of call handoff addressed by certain embodiments of the invention. In FIG. 7, a UE 702 is travelling in a direction 710 that traverses the coverage areas 706 and 716 of base stations (also referred to as cells herein) 704 and 714. While on its path 708, UE 720, may have established an emergency call through cell 704. Certain aspects of the present disclosure apply equally to calls established and maintained in an LTE RAT or in another type of RAT, including a circuit switched RAT such as 1xRTT, W-CDMA, GSM, or another RAT. However, and for simplicity of description only, it will be assumed that cells 704 and 714 provide UE 702 with LTE-based service.

As depicted, UE 702 is traveling through an area 712 in which UE 702 can detect both cells 704 and 714. UE 702 may provide measurement reports to the core network (through serving cell 704) that indicate the presence and availability of cell 714 and the measurement reports may show increasing signal strength and/or channel quality associated with cell 714 and/or decreasing signal strength and/or channel quality associated with cell 704. At some point, the network may determine that cell 704 should handoff the emergency call to cell 714. Certain aspects of this disclosure describe methods for improving the reliability of emergency call handoff to a packet-switched network such as LTE, such that the emergency call is less likely to be dropped or disrupted during, or as a result of, a handoff attempt.

In the example, UE 702 is capable of establishing and maintaining emergency calls through a packet data network including LTE. Voice calls, including emergency calls, may be carried over LTE when the UE 702 supports VoLTE. Emergency calls are typically assigned the highest priority of all calls and, accordingly, certain embodiments of the invention provide systems and methods that can minimize and/or avoid dropped calls handed-off to a VoLTE-based service.

Some embodiments can reduce or eliminate dropped calls caused by high uplink block error rate (BLER). Uplink BLER relates to measured signal quality of received uplink signals and may correspond to the proportion of received data blocks that exhibit decoding errors. BLER may be indicated by a maximum retransmit indication in RLC. Some embodiments can reduce or eliminate dropped calls caused by high download BLER and/or low radio link monitoring (RLM) signal to noise ratio by modifying the UE 702 measurement reporting behavior.

In one example, dropped calls may be caused by slow measurement reporting when multiple radio access technologies (RAT), particularly in geographical areas where inter-RAT (IRAT) reselection is enabled. Handover performance in IRAT areas 712 and in weak coverage areas may be improved by adjusting a time-to-trigger (TTT) parameter of the UE 702. TTT is typically used to mitigate a “ping-pong” handover effect, in which UE 702 is handed off multiple times between two or more RATs 706 and 716 while moving through an IRAT area 712. A longer TTT may be introduced to ensure that the channel quality available in the target RAT 716 is consistently better than the channel quality in the source RAT 706. However, a prolonged TTT may cause undesirable radio link failure (RLF) when delayed hand over causes the UE 702 to be handed-off to a weaker RAT 716. In some embodiments, UE 702 may scale the TTT when the UE 702 has established an emergency call on a data radio bearer (DRB) using VoLTE. For example, handover may be indicated when a currently used UMTS cell quality has dropped below a first threshold value and/or a GSM cell quality had risen above a second threshold (an “event 3A handover”). The TTT setting may cause a UE 702 to delay sending measurement reports to the network and on the value of the TTT.

Delays in reporting may, in turn, delay a handover decision and a handover command may not be issued before the call is dropped. In one example, certain portions of an IRAT area may include network coverage holes where a gap in service for one or more RATs may cause a UE 702 moving through the coverage hole to lose service on one RAT 706 when service can be provided on a second RAT 716. Delayed reporting of coverage holes, interference and low serving cell power may result in VoLTE RLF and/or call drops when conventional TTT is applied. Accordingly, a VoLTE emergency call may be dropped. When the UE 702 is moving quickly through the IRAT 712, conventional TTT values may cause delayed measurement reporting to result in the network receiving stale measurements, which may result in generation of incorrect handover commands.

In the example depicted in FIG. 7, UE 702 may be receiving service from LTE cell 704 and may transmit a measurement report subject to TTT delay while moving toward an edge of the coverage area 706 of serving cell 704. By the time the network generates and sends a handover command, UE 702 may have already left the coverage area 706 of the serving cell 704 and may have traveled further into the coverage area 716 of cell 714.

In some embodiments, an entity of the core network may send a TTT scaling factor to one or more UEs 702 in an RRC signaling message. Scaling the TTT may modify the delay adopted for handover decisions by reducing the TTT for VoLTE emergency call scenarios, such that the UE 702 provides measurement reports as soon as possible. Accordingly, the UE 702 may transmit a measurement report indicating improved quality of service from cell 714 over serving cell 704 as UE 702 is approaching the outer limits of coverage area 706. Having scaled TTT to a lower value using a scaling factor, the network may initiate a handover to cell 714 before UE 702 leaves coverage area 706. The scaling factor may be signaled by the network in a RRC message. The TTT may be scaled by a scaling factor determined based on changes in estimated or measured channel quality in the target RAT 716 and the serving RAT 706.

Some embodiments can reduce or eliminate dropped calls caused by connected-mode random access channel (RACH) failures. UE 702 may use RACH as a transport channel to access LTE cell 714 when uplink transmission resources have not been allocated for the UE 702, or when the UE 702 has not obtained accurate uplink timing synchronization. The UE 702 may initiate a transmission on RACH uplink using power levels that are based on measured downlink RACH power. However, the downlink power levels may not accurately predict the needed uplink power for various reasons associated with the uplink channel. For example, RACH communications may be contention-based and collisions may occur when multiple UEs 702 use RACH.

Some embodiments improve RACH handover performance when an emergency call has been established using VoLTE. In weak coverage areas, a network may decide to hand over UE 702 to another cell 714 that offers marginally better coverage, or in which there is a high probability of RACH failure. RACH failure may relate to an inability of the base station 714 to detect and/or decode signals from UE 702 after handoff, resulting in handoff delays that can result in glitches in the VoLTE emergency call.

Certain embodiments of the invention ensure that RACH on the destination cell 714 is available to maintain the emergency call when UE 702 is handed over from LTE cell 704 to a different LTE cell 714. Power control parameters may be adjusted for RACH in order to reduce handover delays by ensuring that a target base station 714 is able to receive and decode signals sent by UE 702 on the first attempt. In areas where signaling is limited by interference, the network may not be able to “hear” the UE 702 on its first attempt and RACH retransmissions may be required. The likelihood of retransmission may be reduced by transmitting the initial RACH with a higher uplink power. Accordingly, UE 702 may be configured to over-estimate downlink path loss in order to cause RACH uplink power to be increased, particularly for the initial preamble transmit power. Increasing RACH uplink power may trigger RACH with a higher initial preamble transmit power. In some embodiments, an uplink power level may be computed using a reduced downlink power measurement and subsequently adding an offset power level and/or applying a multiplier to an uplink power level computed from a measured downlink power level. In some embodiments, an uplink power level may be computed using an increased estimate of channel power loss by, for example, using a reduced value of the measured downlink power to calculate the uplink power level. In one example, uplink power level is selected by using the measured downlink power as an index to select a base, or starting power level. In another example, UE 702 may select a highest available power level as the starting power level.

In some embodiments, a ramp-up power step for RACH preambles may be defined when an emergency call is to be handed-off to an LTE network. The ramp-up power step defines an incremental power level to be used if base station 714 is unable to properly receive a RACH preamble from UE 702. The power level may be increased as defined by the ramp-up power step value before the transmission is retried. When an emergency call is handed-off, the UE 702 may be configured to use is higher ramp-up step than for other types of calls. The higher step value causes the UE 702 to ramp to maximum power as soon as possible. Power ramp-up parameters may be sent in a system information block (SIB) and one or more other ramp-up parameters may be sent in the SIB. In particular, one or more parameters specific to VoLTE emergency calls may be sent in SIB2 or in another SIB.

Certain embodiments improve call success rate in areas of cells 706, 716 that are experiencing heavy RF interference. In areas subjected to high levels of RF pollution, both uplink and downlink interference from neighboring cells can severely degrade emergency call performance and can result in call drops. LTE systems may address interference by provisioning HARQ transmissions using semi-persistent scheduling (SPS) for DRBs that carry VoLTE traffic. SPS has an interval that is typically 20 ms, which corresponds to vocoder frame rate. If UE 702 is experiencing high downlink BLER, it is likely that vocoder frames will be lost because RLC is typically configured in an unacknowledged mode (UM) for SPS whereby RLC level retransmissions are provided on a VoLTE DRB. Loss of packets can degrade call quality.

In certain embodiments, the network may increase SPS grant scheduling rate for downlink and uplink bearers used for VoLTE emergency calls. The network may increase the downlink SPS grant scheduling when high downlink BLER is observed on a VoLTE DRB and may increase the uplink SPS grant scheduling when high uplink BLER is observed. The scheduling rate may be set to a value that is selected based on actual BLER observed on the channel.

VoLTE may be operated as a multi-radio access bearer (multi-RAB) service in which voice traffic in may be communicated using RLC UM, while signaling is communicated using RLC acknowledged mode (AM). In highly RF-polluted areas, higher uplink BLER may result in multiple RLC retransmissions for AM bearers. When the RLC max retransmissions in uplink exceeds a threshold, typically set as maximum value (RLC_MAX_RETX), radio link failure may be indicated and an emergency call may be dropped. Some embodiments may increase the RLC_MAX_RETX parameter for AM DRBs when VoLTE emergency calls are established. Accordingly, the dropping of emergency calls in pilot polluted areas may be prevented when higher uplink BLER is measured.

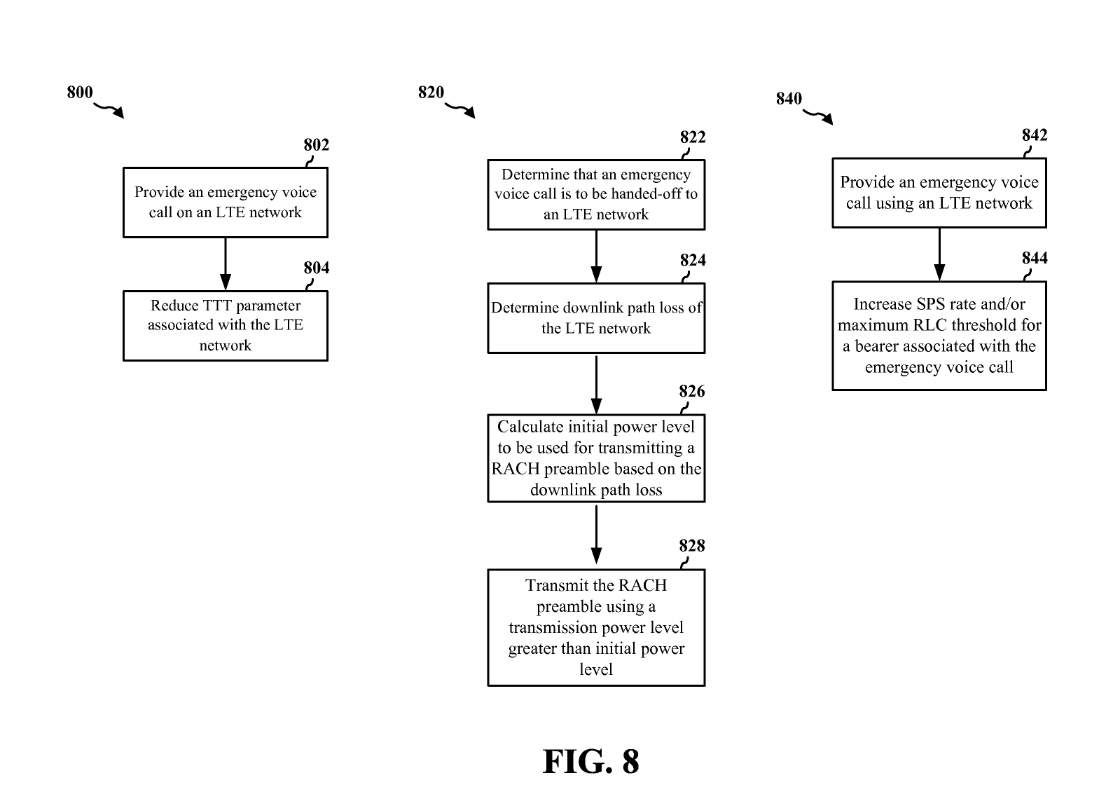

FIG. 8 includes a first flow chart 800 of a method of wireless communication. The method may be performed by a base station, such as an eNB 704. At step 802, the eNB 704 provides an emergency voice call on a LTE network.

At step 804, the eNB 704 reduces a TTT parameter associated with the LTE network. The TTT parameter corresponds to a time by which a UE 702 may delay transmission of a network measurement report. Reducing the TTT parameter may include transmitting a scaling factor to the UE 702, wherein the scaling factor corresponds to a factor by which a UE 702 may modify a TTT defined for non-emergency voice calls provided on the LTE network. The TTT parameter may be reduced to a minimum value, thereby causing the UE 702 to transmit the network measurement report without delay.

In some embodiments, the TTT parameter may be reduced in response to a triggering event. The triggering event may occur when an estimated quality of a serving radio access network is less than a first threshold quality, and an estimated quality of a target radio access network is greater than a second threshold quality. In some configurations, the first threshold quality may be equal to the second threshold quality.

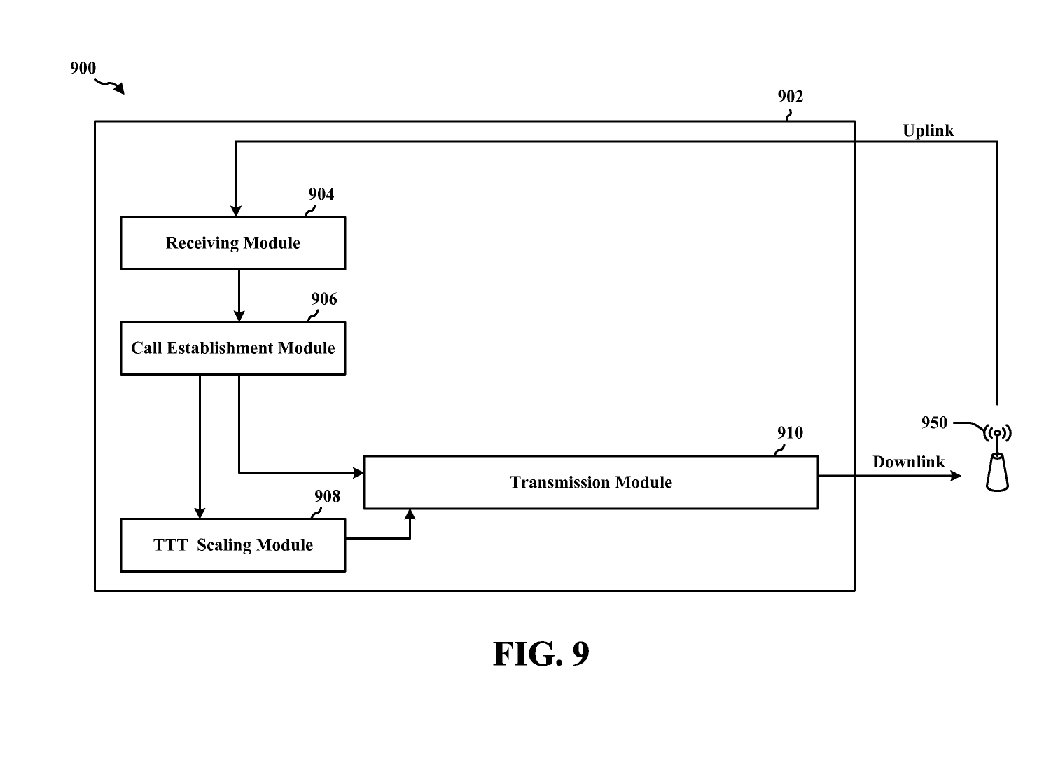

FIG. 9 is a flow diagram 900 illustrating the data flow between different modules/means/components in an exemplary apparatus 902 that implements the first flow chart of FIG. 8. The apparatus may be an eNB. The apparatus includes a receiving module 904 that receives and decodes signals from antenna 950, a call establishment module 906 that provides a connection or otherwise establishes an emergency voice call, a TTT scaling module 908 that adjusts and scales a TTT, and a transmission module 910 that transmits information through antenna 950.

The apparatus may include additional modules that perform each of the steps of the algorithm in the aforementioned first flow chart of FIG. 8. As such, each step in the aforementioned first flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

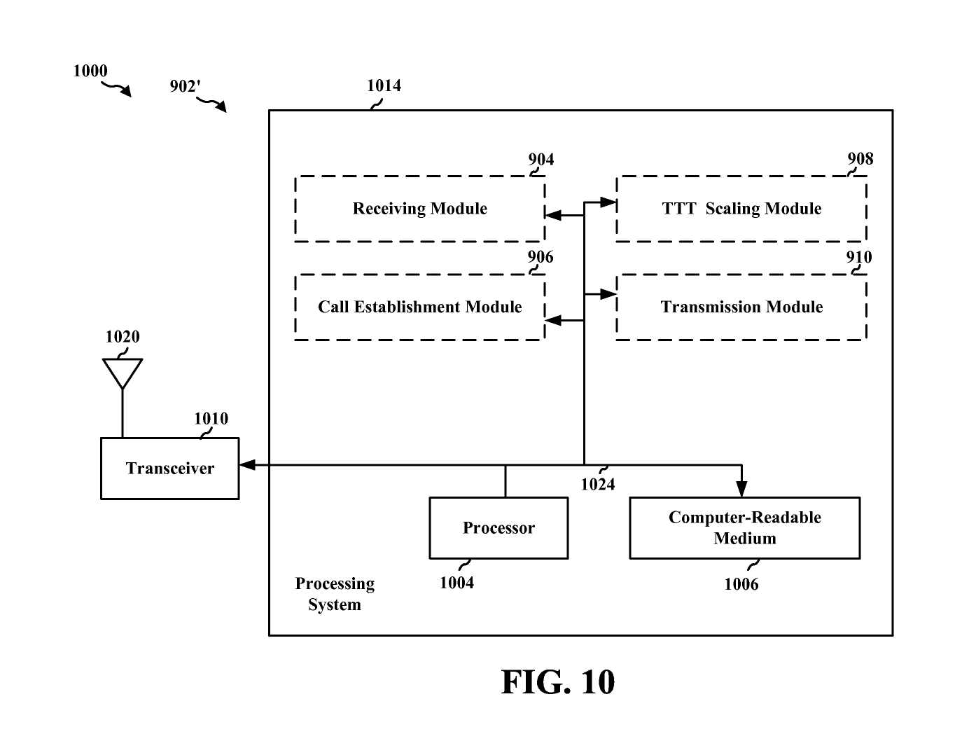

FIG. 10 is a diagram 1000 illustrating an example of a hardware implementation for an apparatus 902′ employing a processing system 1014 to implement the first flow chart of FIG. 8. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1004, the modules 904, 906, 908, 910, and the computer-readable medium 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The processing system 1014 includes a processor 1004 coupled to a computer-readable medium 1006. The processor 1004 is responsible for general processing, including the execution of software stored on the computer-readable medium 1006. The software, when executed by the processor 1004, causes the processing system 1014 to perform the various functions described supra for any particular apparatus. The computer-readable medium 1006 may also be used for storing data that is manipulated by the processor 1004 when executing software. The processing system further includes at least one of the modules 904, 906, 908, and 910. The modules may be software modules running in the processor 1004, resident/stored in the computer readable medium 1006, one or more hardware modules coupled to the processor 1004, or some combination thereof. The processing system 1014 may be a component of the eNB 610 and may include the memory 676 and/or at least one of the TX processor 616, the RX processor 670, and the controller/processor 675.

In one configuration, the apparatus 902/902′ for wireless communication includes means 904 for receiving and decoding signals from a transceiver 1010, means 906 for providing an emergency voice call on an LTE network, means 908 for reducing or otherwise scaling a TTT parameter of the LTE network, and means 910 for transmitting information through a transceiver 1010 and an antenna 1020.

The aforementioned means may be one or more of the aforementioned modules of the apparatus 902 and/or the processing system 1014 of the apparatus 902′ configured to perform the functions recited by the aforementioned means. As described supra, the processing system 1014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

FIG. 8 includes a second flow chart 820 of a method of wireless communication. The method may be performed by a UE 702. At step 822, the UE 702 determines that an emergency voice call is to be handed-off to an LTE network.

At step 824, the UE 702 determines path loss in a downlink random access channel (RACH) of the LTE network.

At step 826, the UE 702 calculates an uplink power level to be used for transmissions on an uplink RACH. The uplink power level may be based on the path loss in the downlink RACH. Calculating the uplink power level to be used for transmissions on the uplink RACH may include overestimating the path loss of the downlink RACH.

At step 828, the UE 702 transmits a RACH preamble on the uplink RACH using a power level greater that the power level calculated based on the path loss in the downlink RACH. Transmitting the RACH preamble on the uplink RACH may include applying a multiplier to a power level calculated based on the path loss in the downlink RACH. Transmitting the RACH preamble on the uplink RACH using a power level greater that the power level calculated based on the path loss in the downlink RACH may include increasing a ramp-up power step, wherein the ramp-up power step is used to increase the power level of successive ramp-up RACH transmissions of the RACH preamble. The ramp-up may have a value for the emergency voice call that is greater than a network-defined value used for non-emergency voice calls.

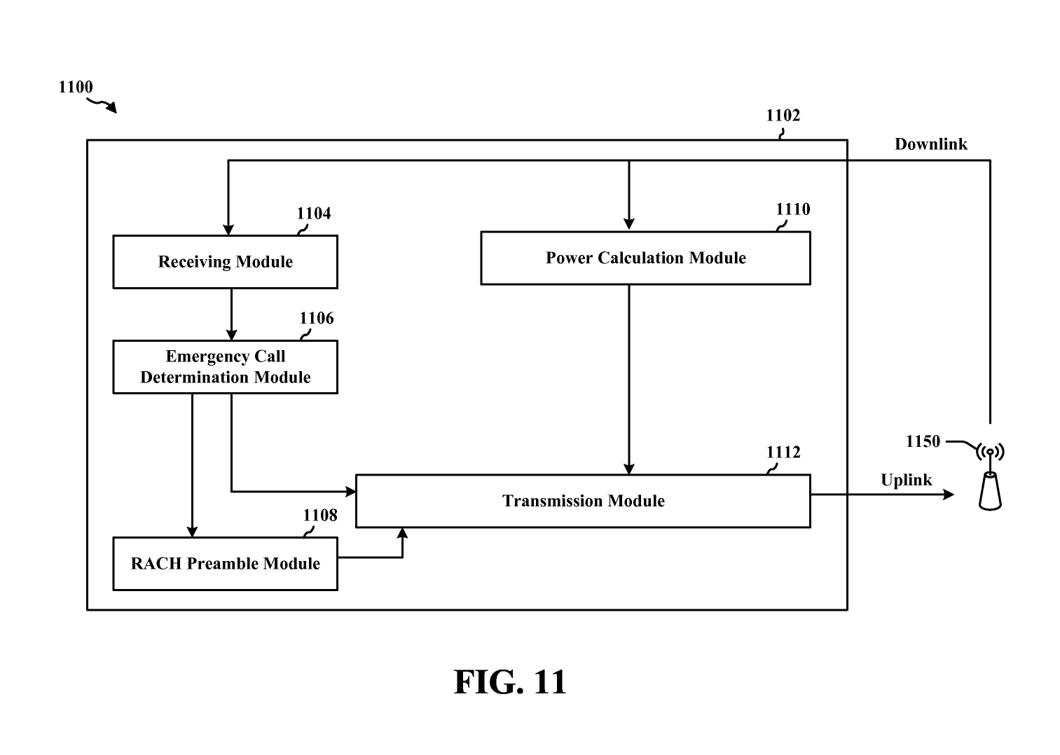

FIG. 11 is a flow diagram 1100 illustrating the data flow between different modules/means/components in an exemplary apparatus 1102 that implements the second flow chart of FIG. 8. The apparatus may be a UE 702. The apparatus includes a receiving module 1104 that receives wireless signals from antenna 1150, a emergency call determination module 1106 that determines that an emergency call has been established, a RACH preamble module 1108 that prepares a RACH preamble for transmission, a power calculation module 1110 that calculates power for the transmission of the RACH preamble, and a transmission module 1112 that transmits the RACH preamble through the antenna 1150.

The apparatus may include additional modules that perform each of the steps of the algorithm in the aforementioned second flow chart of FIG. 8. As such, each step in the aforementioned second flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

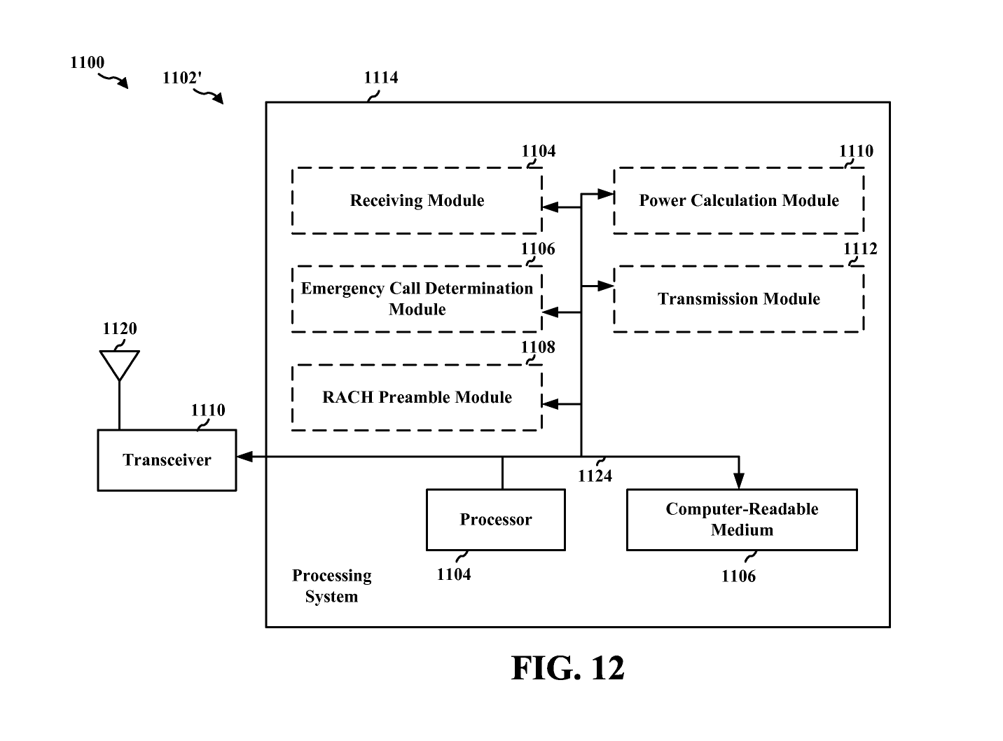

FIG. 12 is a diagram 1200 illustrating an example of a hardware implementation for an apparatus 1102′ employing a processing system 1214 to implement the second flow chart of FIG. 8. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, 1110, 1112, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, 1108, 1110, and 1112. The modules may be software modules running in the processor 1204, resident/stored in the computer readable medium 1206, one or more hardware modules coupled to the processor 1204, or some combination thereof. The processing system 1214 may be a component of the UE 650 and may include the memory 660 and/or at least one of the TX processor 668, the RX processor 656, and the controller/processor 659.

In one configuration, the apparatus 1102/1102′ for wireless communication includes means 1104 for receiving information from an LTE network, means 1106 for determining that an emergency voice call is to be handed-off to the LTE network, means 1110 for determining a downlink path loss of the LTE network and calculating an initial power to be used for transmitting a RACH preamble based on the downlink path loss, means 1108 and 1110 for transmitting the RACH preamble.

The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

FIG. 8 includes a third flow chart 840 of a method of wireless communication. The method may be performed by an eNB 704. At step 842, the eNB 704 provides an emergency voice call using a LTE network.

At step 844, the eNB 704 increases one or more of an SPS rate of a bearer associated with the emergency voice call, and a maximum radio link control threshold. The SPS rate may be increased to a rate greater than a frame rate of a vocoder that handles the emergency voice call. The maximum radio link control threshold may be increased for acknowledgement mode radio link control communications associated with the emergency call.

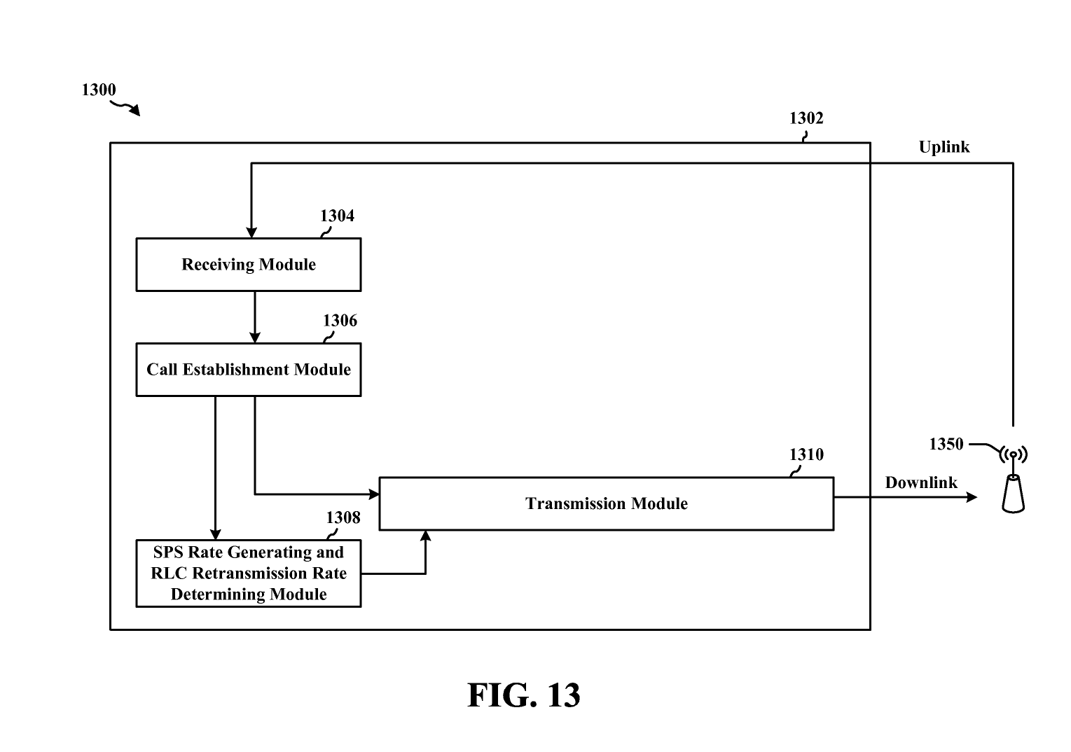

FIG. 13 is a flow diagram 1300 illustrating the data flow between different modules/means/components in an exemplary apparatus 1302 that implements the third flow chart of FIG. 8. The apparatus may be an eNB. The apparatus includes a receiving module 1304 that receives signals from a wireless network, a call establishment module 1306 that establishes or maintains a voice call through the LTE network, a SPS rate generating and RLC retransmission determining module 1308 that generates an SPS rate, and a transmission module 1310 that transmits information over the LTE network.

The apparatus may include additional modules that perform each of the steps of the algorithm in the aforementioned third flow chart of FIG. 8. As such, each step in the aforementioned third flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

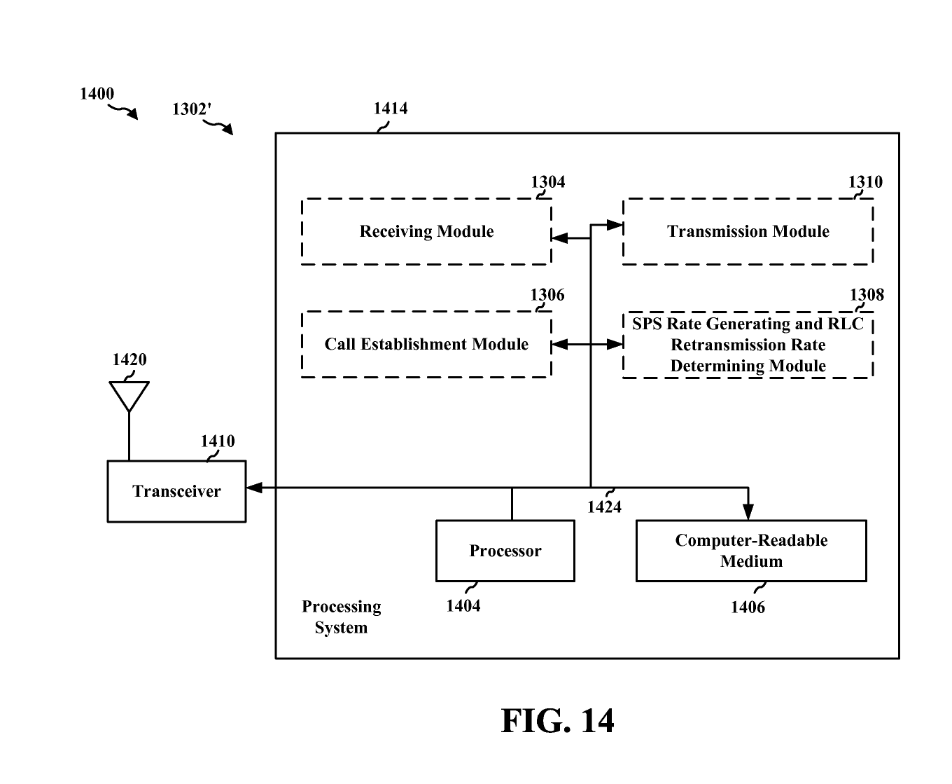

FIG. 14 is a diagram 1400 illustrating an example of a hardware implementation for an apparatus 1302′ employing a processing system 1414 to implement the third flow chart of FIG. 8. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308, and 1310. The modules may be software modules running in the processor 1404, resident/stored in the computer readable medium 1406, one or more hardware modules coupled to the processor 1404, or some combination thereof. The processing system 1414 may be a component of the eNB 610 and may include the memory 676 and/or at least one of the TX processor 616, the RX processor 670, and the controller/processor 675.

In one configuration, the apparatus 1302/1302′ for wireless communication includes means 1304 for receiving signals from an LTE network, means 1306 for providing an emergency voice call using the LTE network, and means 1308 for increasing one or more of a semi-persistent scheduling (SPS) rate of a bearer associated with the emergency voice call, and a maximum radio link control retransmission rate threshold.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
providing an emergency voice call on a long-term evolution (LTE) network; and
reducing a time-to-trigger (TTT) parameter associated with the LTE network,
wherein the TTT parameter corresponds to a time by which a user equipment (UE) delays transmission of a network measurement report.

2. The method of claim 1, wherein reducing the TTT parameter comprises transmitting a scaling factor to the UE, wherein the scaling factor corresponds to a factor by which the UE modifies a TTT defined for non-emergency voice calls provided on the LTE network.

3. The method of claim 2, wherein the TTT parameter is reduced to a minimum value, thereby causing the UE to transmit the network measurement report without delay.

4. The method of claim 1, wherein the TTT parameter is reduced in response to a triggering event.

5. The method of claim 4, wherein the triggering event occurs when an estimated quality of a serving radio access network is less than a first threshold quality, and an estimated quality of a target radio access network is greater than a second threshold quality.

6. The method of claim 5, wherein the first threshold quality is equal to the second threshold quality.

7. An apparatus for wireless communication, comprising:
means for providing an emergency voice call on a long-term evolution (LTE) network; and
means for reducing a time-to-trigger (TTT) parameter of the LTE network,
wherein the TTT parameter corresponds to a time by which a user equipment (UE) delays transmission of a network measurement report.

8. The apparatus of claim 7, wherein the means for reducing the TTT parameter is configured to transmit a scaling factor to the UE, wherein the scaling factor corresponds to a factor by which the UE modifies a TTT defined for non-emergency voice calls provided on the LTE network.

9. The apparatus of claim 8, wherein the TTT parameter is reduced to a minimum value, thereby causing the UE to transmit the network measurement report without delay.

10. The apparatus of claim 7, wherein the TTT parameter is reduced in response to a triggering event.

11. The apparatus of claim 10, wherein the triggering event occurs when an estimated quality of a serving radio access network is less than a first threshold quality, and an estimated quality of a target radio access network is greater than a second threshold quality.

12. The apparatus of claim 11, wherein the first threshold quality is equal to the second threshold quality.

13. An apparatus for wireless communication, comprising:
a processing system configured to:
provide an emergency voice call on a long-term evolution (LTE) network; and
reduce a time-to-trigger (TTT) parameter associated with the LTE network,
wherein the TTT parameter corresponds to a time by which a user equipment (UE) delays transmission of a network measurement report.

14. A computer program product, comprising:
a computer-readable medium comprising code for:
providing an emergency voice call on a long-term evolution (LTE) network; and
reducing a time-to-trigger (TTT) parameter associated with the LTE network,
wherein the TTT parameter corresponds to a time by which a user equipment (UE) delays transmission of a network measurement report.

15. A method of wireless communication, comprising:
determining that an emergency voice call is to be handed-off to a long-term evolution (LTE) network;
determining a path loss in a downlink random access channel (RACH) of the LTE network;
calculating an uplink power level to be used for transmissions on an uplink RACH, the uplink power level being based on the path loss in the downlink RACH; and
transmitting a RACH preamble on the uplink RACH using a power level greater that the power level calculated based on the path loss in the downlink RACH.

16. The method of claim 15, wherein transmitting the RACH preamble on the uplink RACH includes applying a multiplier to a power level calculated based on the path loss in the downlink RACH.

17. The method of claim 15, wherein calculating the uplink power level to be used for transmissions on the uplink RACH includes overestimating the path loss of the downlink RACH.

18. The method of claim 15, transmitting the RACH preamble on the uplink RACH using a power level greater that the power level calculated based on the path loss in the downlink RACH includes increasing a ramp-up power step, wherein the ramp-up power step is used to increase power level for successive ramp-up RACH transmissions of the RACH preamble.

19. An apparatus for wireless communication, comprising:
means for determining that an emergency voice call is to be handed-off to a long-term evolution (LTE) network;
means for determining a path loss in a downlink random access channel (RACH) of the LTE network;
means for calculating an uplink power level to be used for transmissions on an uplink RACH, the uplink power level being based on the path loss in the downlink RACH; and
means for transmitting a RACH preamble on the uplink RACH using a power level greater that the power level calculated based on the path loss in the downlink RACH.

20. The apparatus of claim 19, wherein the means for transmitting the RACH preamble on the uplink RACH is configured to apply a multiplier to a power level calculated based on the path loss in the downlink RACH.

21. The apparatus of claim 19, wherein the means for calculating the uplink power level to be used for transmissions on the uplink RACH is configured to overestimate the path loss of the downlink RACH.

22. The apparatus of claim 19, wherein the means for transmitting the RACH preamble on the uplink RACH using a power level greater that the power level calculated based on the path loss in the downlink RACH is configured to increase a ramp-up power step, wherein the ramp-up power step is used to increase power level for successive ramp-up RACH transmissions of the RACH preamble.

23. An apparatus for wireless communication, comprising:
a processing system configured to:
determine that an emergency voice call is to be handed-off to a long-term evolution (LTE) network;
determine a path loss in a downlink random access channel (RACH) of the LTE network;
calculate an uplink power level to be used for transmissions on an uplink RACH, the uplink power level being based on the path loss in the downlink RACH; and
transmit a RACH preamble on the uplink RACH using a power level greater that the power level calculated based on the path loss in the downlink RACH.

24. An apparatus for wireless communication, comprising:
a computer-readable medium comprising code for:
determining that an emergency voice call is to be handed-off to a long-term evolution (LTE) network;
determining a path loss in a downlink random access channel (RACH) of the LTE network;
calculating an uplink power level to be used for transmissions on an uplink RACH, the uplink power level being based on the path loss in the downlink RACH; and
transmitting a RACH preamble on the uplink RACH using a power level greater that the power level calculated based on the path loss in the downlink RACH.

25. A method of wireless communication, comprising:
providing an emergency voice call using a long-term evolution (LTE) network; and
increasing one or more of a semi-persistent scheduling (SPS) rate of a bearer associated with the emergency voice call, and a maximum radio link control retransmission rate threshold.

26. The method of claim 25, wherein the SPS rate is increased to a rate greater than a frame rate of a vocoder that handles the emergency voice call.

27. The method of claim 25, wherein the maximum radio link control retransmission rate threshold is increased for acknowledgement mode radio link control communications associated with the emergency voice call.

28. An apparatus for wireless communication, comprising:
means for providing an emergency voice call using a long-term evolution (LTE) network; and
means for increasing one or more of a semi-persistent scheduling (SPS) rate of a bearer associated with the emergency voice call, and a maximum radio link control retransmission rate threshold.

29. The apparatus of claim 28, wherein the SPS rate is increased to a rate greater than a frame rate of a vocoder that handles the emergency voice call.

30. The apparatus of claim 28, wherein the maximum radio link control retransmission rate threshold is increased for acknowledgement mode radio link control communications associated with the emergency voice call.

31. An apparatus for wireless communication, comprising:
a processing system configured to:
provide an emergency voice call using a long-term evolution (LTE) network; and
increase one or more of a semi-persistent scheduling (SPS) rate of a bearer associated with the emergency voice call, and a maximum radio link control retransmission rate threshold.

32. A computer program product, comprising:
a computer-readable medium comprising code for:
providing an emergency voice call using a long-term evolution (LTE) network; and
increasing one or more of a semi-persistent scheduling (SPS) rate of a bearer associated with the emergency voice call, and a maximum radio link control retransmission rate threshold.
